(19) United States
(12) Patent Application Publication
(10) Pub. No.: US 2024/0146876 A1
(43) Pub. Date: May 2, 2024

(54) AUDIO VISUALIZATION

(71) Applicant: Zoom Video Communications, Inc., San Jose, CA (US)

(72) Inventors: Zhaofeng Jia, Saratoga, CA (US); Yuhui Chen, San Jose, CA (US)

(21) Appl. No.: 17/978,760

(22) Filed: Nov. 1, 2022

(51) Int. Cl. H04N 7/15; G10L 21/003; H04L 12/18; H04N 7/14

(52) U.S. Cl. CPC H04N 7/152; G10L 21/003; H04L 12/1822; H04N 7/147

(57) ABSTRACT

Various embodiments of an apparatus, method(s), system(s) and computer program product(s) described herein are directed to a Visualization Engine. The Visualization Engine receives audio data associated with a user account accessing a virtual meeting via a communications environment client software application. The Visualization Engine detects presence of a pre-selected type(s) of audio event(s) in the received audio data. The Visualization Engine generates a visualization representative of at least one attribute of the detected audio event(s). During playback of the audio data in the virtual meeting, the Visualization Engine renders the visualization within the communications environment client software application of the user account.

### FIELD

Various embodiments relate generally to digital communication, and more particularly, to online video and audio.

### SUMMARY

The appended Abstract may serve as a summary of this application.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary environment in which some embodiments may operate.

FIG. 2 is a diagram illustrating an exemplary environment in which some embodiments may operate.

FIG. 3 is a diagram illustrating an exemplary flowchart according to some embodiments.

FIG. 4 is a diagram illustrating an exemplary environment in which some embodiments may operate.

FIGS. 5A, 5B and 5C are each a diagram illustrating an exemplary environment in which some embodiments may operate.

FIG. 6 is a diagram illustrating an exemplary environment in which some embodiments may operate.

FIG. 7 is a diagram illustrating an exemplary environment in which some embodiments may operate.

### DETAILED DESCRIPTION OF THE DRAWINGS

Various embodiments of a Visualization Engine are described herein that provide functionality for a detecting an occurrence(s) of a type(s) of audio event and renders visualizations based on attributes and characteristics of and/or changes between the detected audio events.

In this specification, reference is made in detail to specific embodiments of the invention. Some of the embodiments or their aspects are illustrated in the drawings.

During participating in a virtual online meeting in which a user account streams audio data and video data from their computer device, the individual represented by the user account may not be aware of audio problems. However, other participant user accounts accessing the same virtual online meeting may hear the user account's audio problems. For example, a microphone of the computer device associated with the user account may capture an amount of background noise that interferes with the user account's audio data. The individuals represented by the other participant user accounts will be able to hear the background noise in the user account's audio data played back in the virtual online meeting. The user account may not realize the extent to which the background noise exists and to what degree it is interfering with the quality of the user account's audio data being sent to the virtual online meeting. Various embodiments of the Visualization Engine described herein generates and renders a visualization of the detected background noise for the user account. As such, the Visualization Engine provides the individual represented by the user account with a visual cue(s) within a virtual online meeting environment that corresponds to the occurrence of audio events that the individual would otherwise not be able to perceive.

Various embodiments of an apparatus, method(s), system(s) and computer program product(s) described herein are directed to a Visualization Engine. The Visualization Engine receives audio data associated with a user account accessing a virtual meeting via a communications environment client software application. The Visualization Engine detects presence of a pre-selected type(s) of audio event(s) in the received audio data. The Visualization Engine generates a visualization representative of at least one attribute of the detected audio event(s). During playback of the audio data in the virtual meeting, the Visualization Engine renders the visualization within the communications environment client software application of the user account.

Various embodiments of the Visualization Engine detect various types of audio events captured by the user account's computer device, such as background noise, and renders a visualization of the detected audio events during playback of the user account's audio data in the virtual online meeting. The Visualization Engine renders the visualization via a client software application implemented at the user account's computer device for accessing the virtual online meeting.

In some embodiments, the Visualization Engine renders the visualization in the instance of the client software application executing at the user account's computer device. That is, the visualization may be rendered within the virtual online meeting environment of the client software application and may only be rendered for presentation to the user account. For example, the Visualization Engine may render the visualization in a user account communications interface.

In various embodiments, the Visualization Engine may also send the visualization to the virtual online meeting in order for presentation of the visualization in another virtual online meeting environment of a client software application executing at a computer device(s) of a participant user account(s). For example, the Visualization Engine may render the visualization in a participant user account communications interface.

In various embodiments, the user account selects the types of audio events for the visualization. The user account may select a plurality of types of audio events. As the Visualization Engine detects respective occurrences of the various types of pre-selected audio events, the Visualization Engines feeds data representative of the detected audio event occurrences to a machine learning model(s) implemented within the client software application. The machine learning model(s) returns visualization output based on a combination of the attributes of the detected different types of audio event occurrences. The Visualization Engine generates and renders the visualization based at least in part on the visualization output returned by the machine learning model(s).

In various embodiments, the Visualization Engine may render a visualization(s) as a visualization background within the video stream that corresponds with the user account. For example, the Visualization Engine may render the visualization(s) as a virtual background of the user account's video stream presented in a user account communications interface.

In various embodiments, the Visualization Engine may render a visualization(s) in a portion(s) of a background of a meeting window presented in the virtual online meeting environment of the client software application. For example, the Visualization Engine may render the visualization(s) in the padding of a user account communications interface.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the invention. The invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

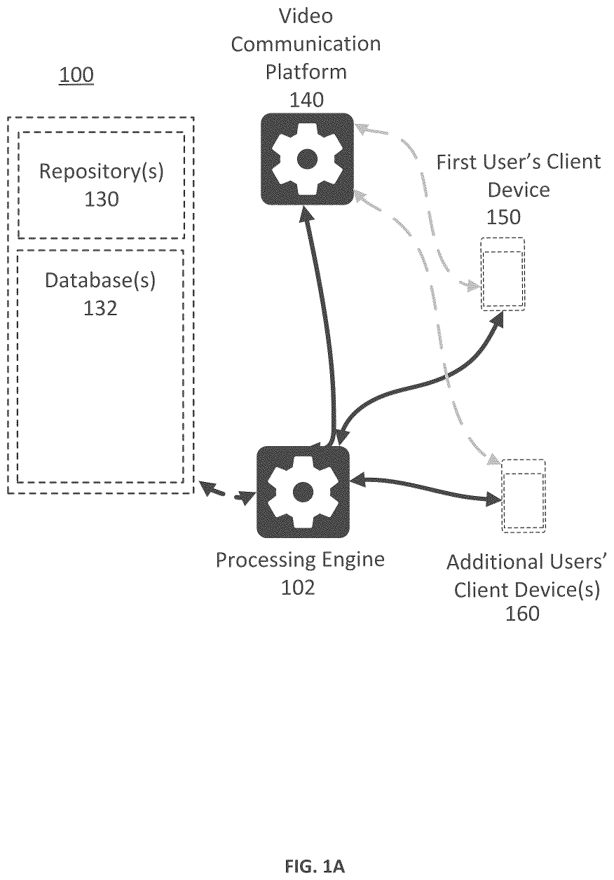

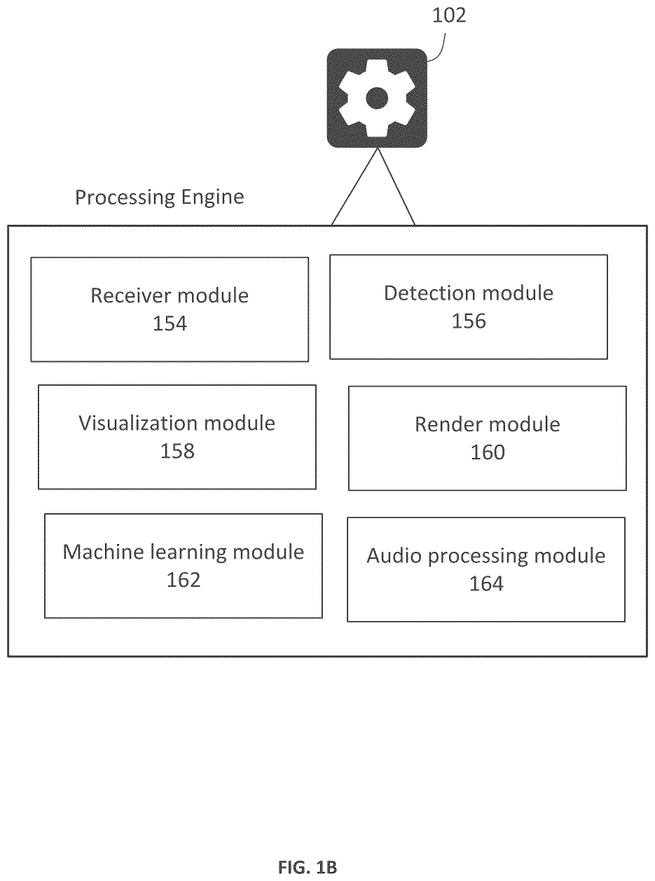

FIG. 1A is a diagram illustrating an exemplary environment in which some embodiments may operate. In the exemplary environment 100, a sending client device 150, one or more receiving client device(s) 160 are connected to a processing engine 102 and, optionally, a communication platform 140. The processing engine 102 is connected to the communication platform 140, and optionally connected to one or more repositories 130 and/or databases 132 of historical virtual online event data, such as historical virtual meeting data One or more of the databases may be combined or split into multiple databases. The sending client device 150 and receiving client device(s) 160 in this environment may be computers, and the communication platform server 140 and processing engine 102 may be applications or software hosted on a computer or multiple computers which are communicatively coupled via remote server or locally.

The exemplary environment 100 is illustrated with only one sending client device, one receiving client device, one processing engine, and one communication platform, though in practice there may be more or fewer sending client devices, receiving client devices, processing engines, and/or communication platforms. In some embodiments, the sending client device, receiving client device, processing engine, and/or communication platform may be part of the same computer or device.

In an embodiment(s), the processing engine 102 may perform methods described herein. In some embodiments, this may be accomplished via communication with the sending client device, receiving client device(s), processing engine 102, communication platform 140, and/or other device(s) over a network between the device(s) and an application server or some other network server. In some embodiments, the processing engine 102 is an application, browser extension, or other piece of software hosted on a computer or similar device or is itself a computer or similar device configured to host an application, browser extension, or other piece of software to perform some of the methods and embodiments herein.

Sending client device 150 and receiving client device(s) 160 are devices with a display configured to present information to a user of the device. In some embodiments, the sending client device 150 and receiving client device(s) 160 present information in the form of a user interface (UI) with UI elements or components. In some embodiments, the sending client device 150 and receiving client device(s) 160 send and receive signals and/or information to the processing engine 102 and/or communication platform 140. The sending client device 150 is configured to submit messages (i.e., chat messages, content, files, documents, media, or other forms of information or data) to one or more receiving client device(s) 160. The receiving client device(s) 160 are configured to provide access to such messages to permitted users within an expiration time window. In some embodiments, sending client device 150 and receiving client device(s) are computer devices capable of hosting and executing one or more applications or other programs capable of sending and/or receiving information. In some embodiments, the sending client device 150 and/or receiving client device(s) 160 may be a computer desktop or laptop, mobile phone, virtual assistant, virtual reality or augmented reality device, wearable, or any other suitable device capable of sending and receiving information. In some embodiments, the processing engine 102 and/or communication platform 140 may be hosted in whole or in part as an application or web service executed on the sending client device 150 and/or receiving client device(s) 160. In some embodiments, one or more of the communication platform 140, processing engine 102, and sending client device 150 or receiving client device 160 may be the same device. In some embodiments, the sending client device 150 is associated with a sending user account, and the receiving client device(s) 160 are associated with receiving user account(s).

In some embodiments, optional repositories function to store and/or maintain, respectively, user account information associated with the communication platform 140, conversations between two or more user accounts of the communication platform 140, and sensitive messages (which may include sensitive documents, media, or files) which are contained via the processing engine 102. The optional repositories may also store and/or maintain any other suitable information for the processing engine 102 or communication platform 140 to perform elements of the methods and systems herein. In some embodiments, the optional database(s) can be queried by one or more components of system 100 (e.g., by the processing engine 102), and specific stored data in the database(s) can be retrieved.

Communication platform 140 is a platform configured to facilitate communication between two or more parties, such as within a conversation, “chat” (i.e., a chat room or series of public or private chat messages), video conference or meeting, message board or forum, virtual meeting, or other form of digital communication. In some embodiments, the platform 140 may further be associated with a video communication environment and a video communication environment client application executed on one or more computer systems.

FIG. 1B is a diagram illustrating exemplary software modules 154, 156, 158, 160, 162, 164 of a Visualization Engine that may execute at least some of the functionality described herein. According to some embodiments, one or more of exemplary software modules 154, 156, 158, 160, 162 may be part of the processing engine 102. In some embodiments, one or more of the exemplary software modules 154, 156, 158, 160, 162, 164 may be distributed throughout the communication platform 140. In some embodiments, one or more of the exemplary software modules 154, 156, 158, 160, 162, 164 may be implemented within a client device 150, 160.

The module 154 functions to capture and/or receive audio data.

The module 156 functions to detect occurrences of a pre-selected type(s) of audio events in the audio data.

The module 158 functions to generate a visualization(s) representative of the detected occurrences of the pre-selected type(s) of audio events.

The module 160 functions to render the visualization(s).

The module 162 functions to implement and run a machine learning model(s) to return visualization output based at least in part on the detected occurrences of the pre-selected type(s) of audio events.

The module 164 functions to perform audio processing on the audio data.

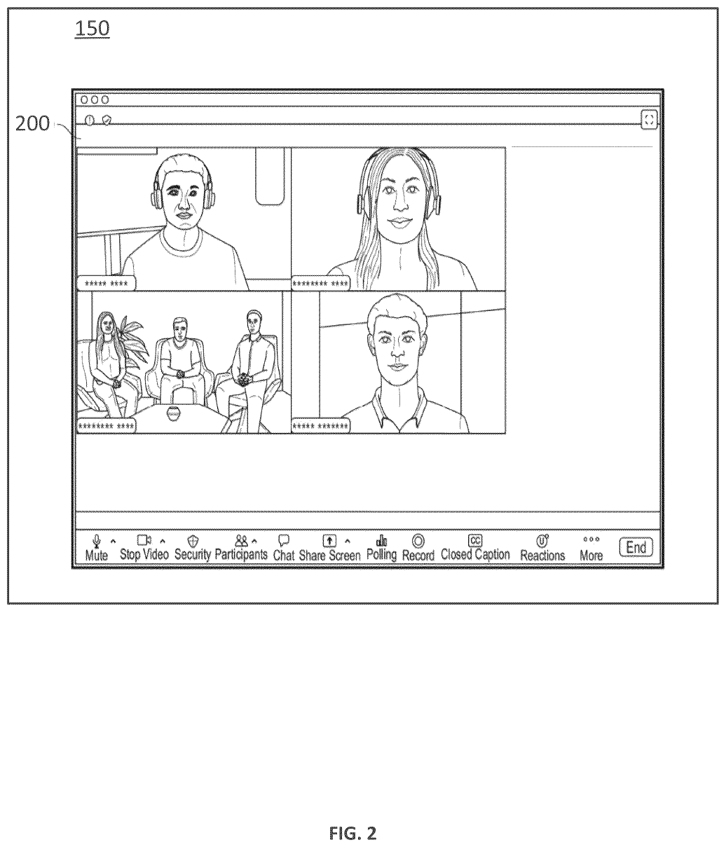

The modules 154, 156, 158, 160, 162 and their functions will be described in further detail in relation to FIGS. 2, 3, 4, 5A, 5B, 5C and/or 6.

As shown in the example of FIG. 2, a user account communications interface 200 for accessing and communicating with the platform 140 and displayed at a computer device 150. For example, the interface 200 may be generated and presented by a communications environment client software application (“client application”) that corresponds with the platform 140. The interface 200 provides access to video data, audio data, chat data and meeting transcription related to an online event(s), such as a virtual webinar or a virtual meeting joined by a user account associated with the computer device 150. The interface 200 further provides various types of tools, functionalities, and settings that can be selected by a user account during an online event (such as a virtual meeting). Various types of virtual meeting control tools, functionalities, and settings are, for example, mute/unmute audio, turn on/off video, start meeting, join meeting, view and call contacts.

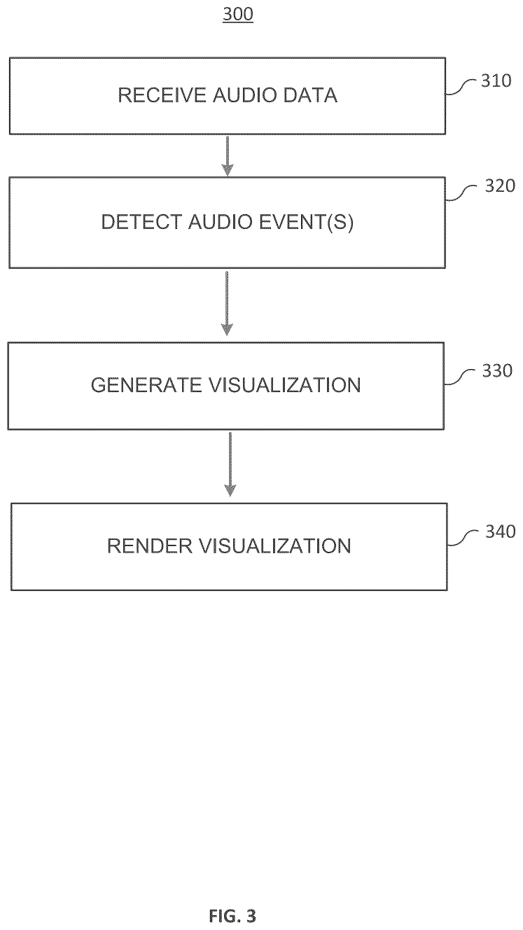

As shown in flowchart diagram 300 of the example of FIG. 3, the Visualization Engine receives audio data associated with a user account accessing a virtual meeting via a communications environment client software application. (Act 310) In various embodiments, the user account is associated with a computer device(s) utilized to access the virtual meeting. Audio data may be captured by the computer device. For example, a microphone(s) of the computer device captures audio data during the user account's participation of the virtual meeting.

The Visualization Engine detects presence of a pre-selected type(s) of audio event(s) in the received audio data. (Act 320) In various embodiments, a user account may select muted audio as a type of audio event to correspond to audio visualization. For example, the type of audio event for muted audio defines respective audio events detected while a mute option has already been selected and/or is active. Another type of audio event may include defining respective audio events with corresponding audio data indicating whether a current physical location of a speaker is outside of a threshold of proximity to the microphone.

The Visualization Engine generates a visualization(s) representative of at least one attribute of the detected audio event(s). (Act 330) Based on determining that audio data has a feature(s), characteristic(s) and/or attribute(s) that corresponds with a preselected type of audio event, the Visualization Engine applies visualization data. The visualization data can be based on the detected occurrence of the audio event's feature(s), characteristic(s) and/or attribute(s). In various embodiments, the visualization data may include a size, color(s) and/or graphical element(s) for visually representing the detected audio event's feature(s), characteristic(s) and/or attribute(s).

In various embodiments, the Visualization Engine detects an occurrence(s) of an audio event while a mute audio functionality has a current status of active and/or enabled. The Visualization Engine generates a visualization based on the current status of the mute audio functionality. The individual represented by the user account will thereby have a visual cue that the other participant user accounts in the virtual meeting are unable to hear the user account's audio because the mute audio functionality is active.

During playback of the audio data in the virtual meeting, the Visualization Engine renders the visualization(s) within the communications environment client software application of the user account. (Act 340) In various embodiments, the visualization can be based on a combination of the current active status of the mute audio functionality and one or more audio events detected while the mute audio functionality is active. The user account may toggle between a first visualization indicating the active status of the mute audio functionality and a second visualization of the detected audio events that would otherwise be transmitted to the other participant user accounts but for the active mute audio functionality. The user account can thereby be provided with a visual cue of the current quality of audio data prior disabling the mute audio functionality. In some embodiments, the first and/or second visualizations are rendered for display only at the computer device of the user account. In other embodiments, the visualization data for the first and/or second visualizations may be transmitted to the virtual meeting for display to the other participant user accounts.

In one or more embodiments, for a type of audio event(s) indicating whether a current physical location of a speaker is outside of a threshold of proximity to the microphone, the Visualization Engine continually changes a visual appearance of the visualization to correspond with changes of audio data for detected occurrence of the audio event. For example, an individual associated with a user account may be seated at a distance that is too far away for a microphone for capture high quality audio data of the individual speaking.

The individual's location with respect to the microphone may continually change due to the individual moving closer to the microphone as the individual speaks. As the individual moves closer, the Visualization Engine detects respective occurrences of audio events indicating the threshold of proximity to the microphone is still not satisfied. However, a more recent detected audio event may be closer to satisfying the threshold of proximity than a previous detected audio event. The Visualization Engine may render the visualization of the more recent detected audio event differently than the visualization of the previous detected audio event. The visualization of the more recent detected audio event thereby provides the individual associated with the user account a visual cue that the threshold of proximity is nearly satisfied.

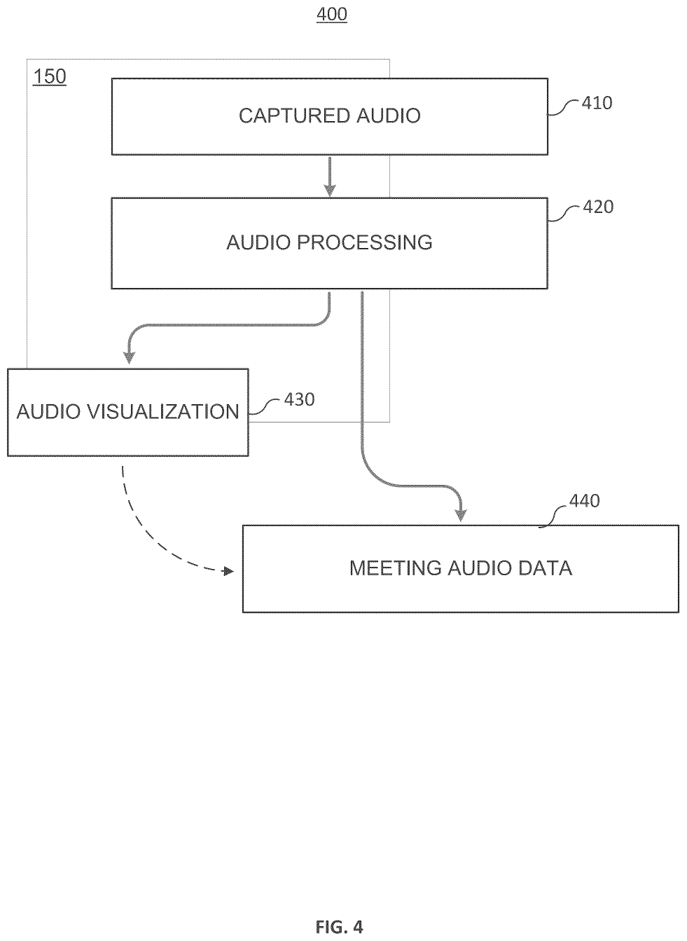

As shown in diagram 400 of the example of FIG. 4, a microphone(s) of a computer device 150 associated with the user account may capture audio and generate audio based on the captured audio (Act 410). The Visualization Engine receives the audio data. The Visualization Engine performs audio processing on the received audio data. (Act 420). In some embodiments, the Visualization Engine applies one or more audio processing algorithms to the received audio data. For example, an audio processing algorithm may result in echo cancellation, noise suppression, automatic gain control and/or speaker voice separation.

The audio processing performed by the Visualization Engine detects occurrences of a pre-selected type(s) of an audio event(s) in the received audio data. During application of the one or more audio processing algorithms to the received audio data, the Visualization Engine identifies audio data that corresponds to a type(s) of audio event pre-selected by the user account. For example, a type of audio event may be any of the following: an instance of voice activity, an instance of background noise, an instance of multi-speaker voice activity, a presence of music, an instance of a variation in audio quality, an instance of audio loss.

In other embodiments, other types of data may be identified by the Visualization Engine and included as part of a particular type of an audio event. The other types of data may be based on one or more of the following: a current status of network conditions, a change in status of network conditions, an instance(s) of audio network package loss, a measure of current computer device quality, and/or a change in the measure of computer device quality. In some embodiments, the visualization may be based solely on one or more of these other types of data.

The Visualization Engine generates and renders a visualization based on the detected audio event(s). (Act 430) The Visualization Engine generates visualization data for the visualization based on the one or more detected occurrences of audio events identified during audio processing. The visualization data may be different for each detected audio events. For example, first visualization data representing a size, color(s) and/or graphical element(s) may correspond to a particular attribute(s), characteristic(s) and/or feature(s) of a first detected audio event whereas second visualization data may represent a different size, different color(s) and/or different graphical element(s) for a subsequent second detected audio event that has respective attribute(s), characteristic(s) and/or feature(s) that are different than those of the first detected audio event.

The Visualization Engine identifies meeting audio data as result of performing the audio processing. The Visualization Engine sends the meeting audio data to the virtual meeting. (Act 440) The meeting audio data may or may not include the detected audio events. In some embodiments, the meeting audio data may be sent to the virtual meeting in relation to video data for a video stream sent from the computing device.

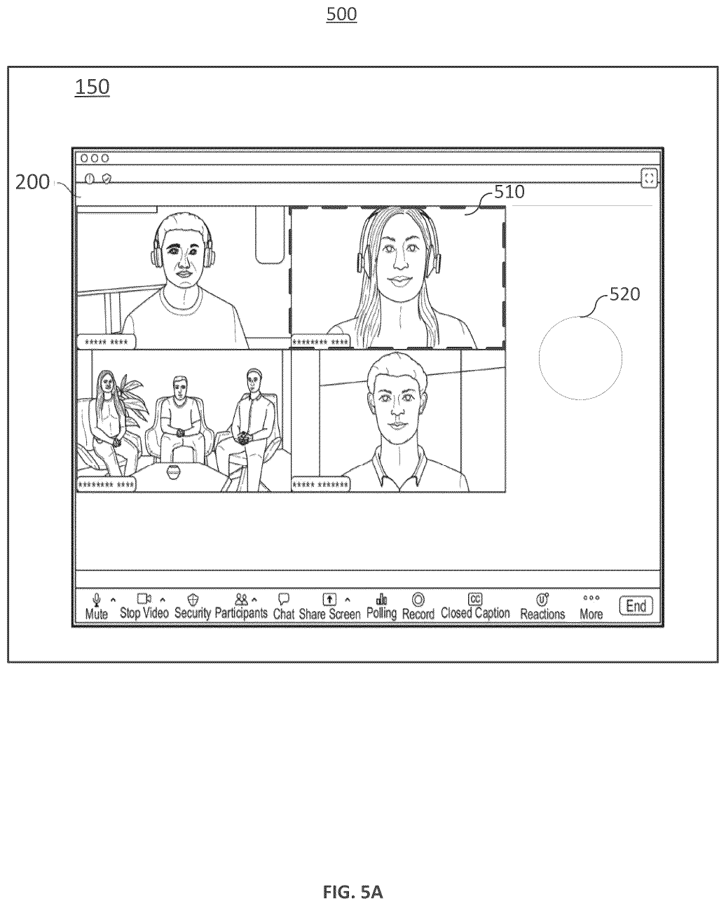

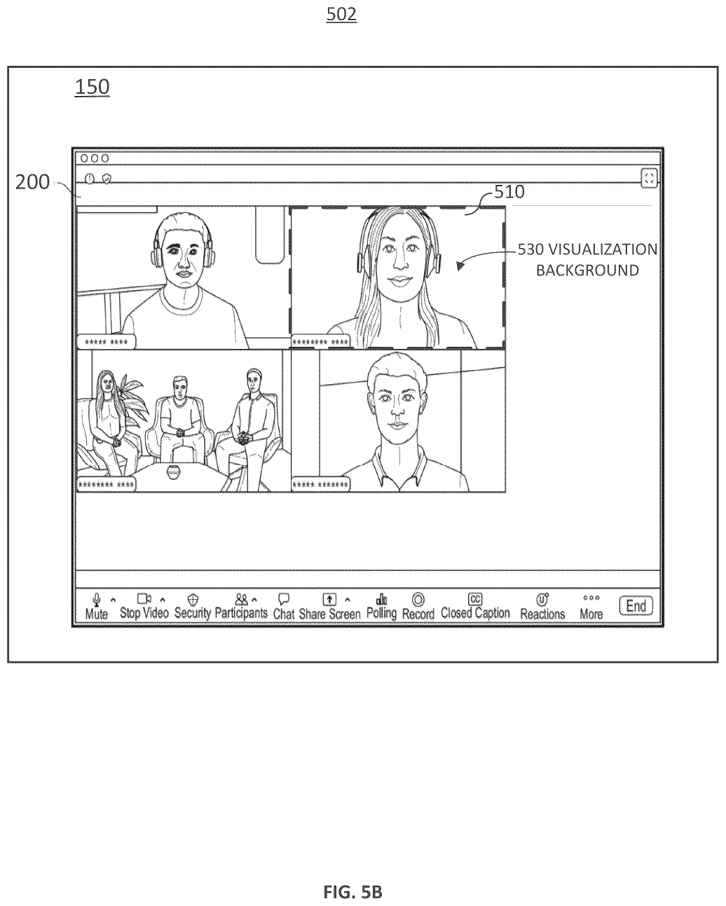

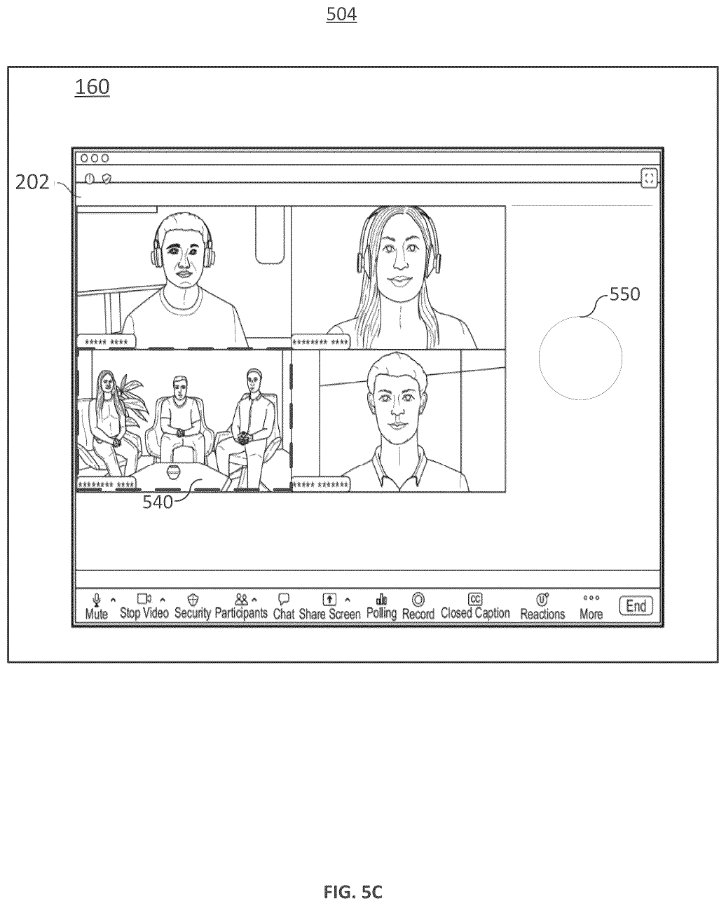

As shown in diagram 500 of the example of FIG. 5A, the interface 200 may correspond to a user account providing a video stream 510 to a virtual meeting. Video data for the video stream is captured by a computer device 150 associated with the user account. The interface 200 is displayed at the computer device 150 associated with the user account. The Visualization Engine renders an audio visualization 520 within the interface 200. For example, the Visualization Engine renders the audio visualization 520 at a portion(s) of the interface's 200 padding. It is understood that the padding is a region(s) within the interface 200 that does not include display of any user account video stream and/or does not include display of various types of tools, functionalities, and settings accessible within the interface 200.

In some embodiments, the audio visualization 520 is dynamically rendered by the Visualization Engine so as to continually represent various attributes and/or characteristics of respective instances of detected audio events in real-time. In various embodiments, the audio visualization 520 is dynamically rendered by the Visualization Engine so as to continually represent changes and/or differences between attributes and/or characteristics of the respective instances of the detected audio events in real-time.

As shown in diagram 502 of the example of FIG. 5B, the Visualization Engine incorporates the data representing the audio visualization with video data for the user account's video stream 510 captured at the computer device 150. The Visualization Engine merges the audio visualization data with the video data and creates a video stream 510 for the user account with a visualization background 530. The visualization background 530 may be a virtual background within the video stream 510 that has one or more visual characteristics (and one or more dynamic changes of the visual characteristics) based on the audio visualization generated by the Visualization Engine.

In some embodiments, the video stream 510 with the visualization background 530 is displayed only within the interface 200 for the user account presented within the client application at the computer device 150. That is, the video stream 510 for the user account that is transmitted to and displayed in the client application instances executing on the respective computer devices of the other participant user accounts accessing the virtual meeting would not include the visualization background 530. In other embodiments, the video stream 510 displayed to the other participant user accounts may also include the visualization background 530. It is understood that an instance of the Visualization Engine may be implemented at each computer device of one or more of the other participant user accounts.

As shown in diagram 504 of the example of FIG. 5C, an interface 202 may correspond to a user account providing a video stream 540 to a virtual meeting. The user account may be associated with a computer device 160 and may also correspond to a particular individual. However, there may be a plurality of individuals proximate to the same computer device 160. Video data captured by the computer device 160 thereby results in a video stream 540 for the virtual meeting that portrays the plurality of proximate to the same computer device 160. The audio data captured by the computer device 160 may also capture audio representative of each of the individuals speaking and/or the individuals speaking concurrently.

The user account may have pre-selected multi-speaker audio events for audio visualization. The Visualization Engine may detect occurrence of audio events in audio data captured by the computer device 160 that represent sound from multiple speakers. The Visualization Engine generates an audio visualization 550 to represent respective occurrences of detected multi-speaker events.

In various embodiments, the appearance of the audio visualization 550 rendered by the Visualization Engine dynamically changes in real-time during the virtual meeting. A first detected multi-speaker event may correspond to three, for example, individuals speaking concurrently. A subsequent second detected multi-speaker event may correspond to two individuals speaking concurrently. The appearance of the audio visualization 550 may dynamically change to provide a different visual cue for each of the first and the second detected multi-speaker events. For example, a size, color and/or graphic of the audio visualization 550 may be selected for the audio visualization 550 for the first detected multi-speaker event. The Visualization Engine may then select a different size, color and/or graphic for the second detected multi-speaker event. It is understood that generation and rendering of the audio visualization 550 may further include a transition animation displayed between visual characteristics of the audio visualization 550 that correspond to the first and the second detected multi-speaker events.

In some embodiments, the audio visualization for detected multi-speaker events may appear as a visualization background in the video stream 540. The video stream 540 with the visualization background may be displayed only by the client application of the user account associated with the computer device 160. In other embodiments, the video stream 540 with visualization background may be displayed by the client application of the user account associated with the computer device 160 and the computer device 160 may transmit visualization data for the audio visualization 550 to the virtual meeting to be received by the computer devices associated with the other participant user accounts accessing the virtual meeting. The other participant user accounts may elect to render an instance of the audio visualization 550, based on the received audio visualization data, via client applications at the respective computer devices associated with those other participant user accounts. In this respect, a local rendered instance of the audio visualization 550 provides a visual cue to a participant user account when there is audio data with multiple speakers portrayed in the video stream 540.

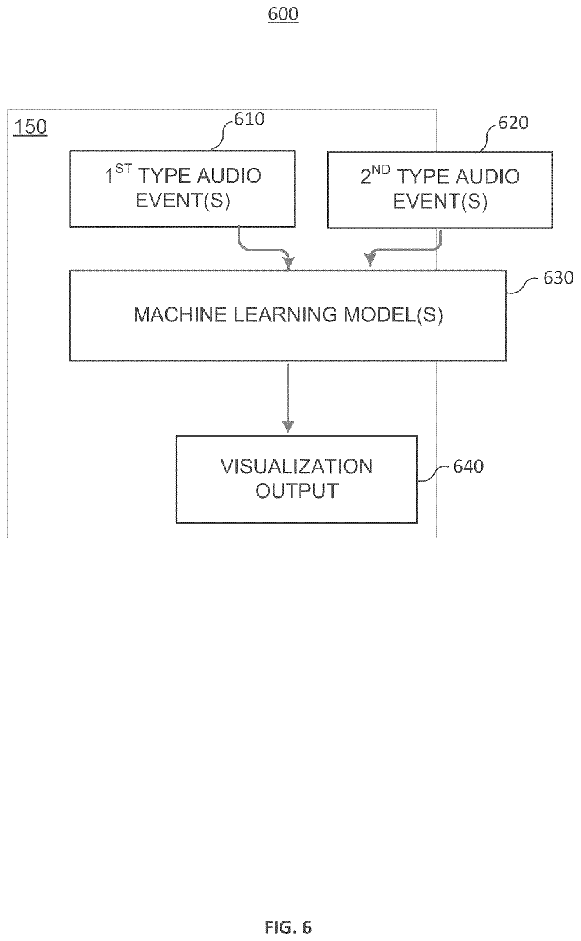

As shown in diagram 600 of the example of FIG. 6, a machine learning model(s) 630 may be implemented on the computer device 150 associated with a user account. In some embodiments, the machine learning model(s) 630 may be part of the client application that corresponds with the user account. The user account may have selected a plurality of types of audio events audio visualization. The Visualization Engine may detect respective occurrences of the plurality of types of audio events in the audio data. The Visualization Engine may perform audio processing on the audio data, which includes the detected audio events.

A feature(s), characteristic(s) and/or attribute(s) of a detected audio events 610, 620 may be fed as input into the machine learning model(s) 630. For example, the Visualization Engine may input a feature(s), characteristic(s) and/or attribute(s) of each of the occurrences of the different types of detected audio events into the machine learning model(s) 630. The machine learning model(s) 630 returns visualization output 640. The Visualization Engine renders an audio visualization based on the visualization output 640.

In some embodiments, the machine learning model(s) 630 may return visualization output 640 based on a combination of the different types of detected audio events 610, 620. An audio visualization based on such visualization output 640 simultaneously provides visual cues about different types of audio events present in the user account's audio data. The machine learning model(s) 630 may return separate visualization output 640 for each different type of audio events 610, 620. The Visualization Engine may render a separate and different audio visualization for each different type of audio events 610, 620. In other embodiment, the user account may toggle between renderings of the different audio visualizations in real-time.

Various embodiments of the Visualization Engine may use any suitable machine learning training techniques to train the machine learning model(s) 630, including, but not limited to a neural net based algorithm, such as Artificial Neural Network, Deep Learning; a robust linear regression algorithm, such as Random Sample Consensus, Huber Regression, or Theil-Sen Estimator; a kernel based approach like a Support Vector Machine and Kernel Ridge Regression; a tree-based algorithm, such as Classification and Regression Tree, Random Forest, Extra Tree, Gradient Boost Machine, or Alternating Model Tree; Naïve Bayes Classifier; and other suitable machine learning algorithms.

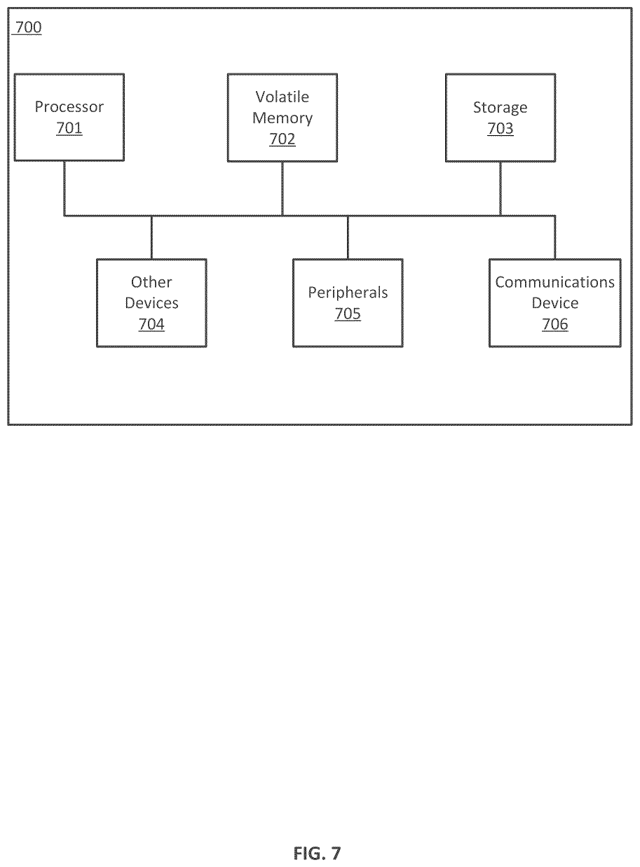

FIG. 7 is a diagram illustrating an exemplary computer that may perform processing in some embodiments. As shown in the example of FIG. 7, an exemplary computer 700 may perform operations consistent with some embodiments. The architecture of computer 700 is exemplary. Computers can be implemented in a variety of other ways. A wide variety of computers can be used in accordance with the embodiments herein.

Processor 701 may perform computing functions such as running computer programs. The volatile memory 702 may provide temporary storage of data for the processor 701. RAM is one kind of volatile memory. Volatile memory typically requires power to maintain its stored information. Storage 703 provides computer storage for data, instructions, and/or arbitrary information. Non-volatile memory, which can preserve data even when not powered and including disks and flash memory, is an example of storage. Storage 703 may be organized as a file system, database, or in other ways. Data, instructions, and information may be loaded from storage 703 into volatile memory 702 for processing by the processor 701.

The computer 700 may include peripherals 705. Peripherals 705 may include input peripherals such as a keyboard, mouse, trackball, video camera, microphone, and other input devices. Peripherals 705 may also include output devices such as a display. Peripherals 705 may include removable media devices such as CD-R and DVD-R recorders/players. Communications device 706 may connect the computer 700 to an external medium. For example, communications device 706 may take the form of a network adapter that provides communications to a network. A computer 700 may also include a variety of other devices 704. The various components of the computer 700 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computer device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

It will be appreciated that the present disclosure may include any one and up to all of the following examples.

Example 1: A computer-implemented method comprising: receiving audio data associated with a user account accessing a virtual meeting via a communications environment client software application; detecting presence of a pre-selected type of audio event in the received audio data;
generating a visualization representative of at least one attribute of the detected audio
event; and during playback of the audio data in the virtual meeting, rendering the visualization within the communications environment client software application of the user account.

Example 2: The method of Example 1, wherein detecting presence of a pre-selected type of audio event in the received audio data comprises: generating meeting audio data by performing audio processing of the received audio data via the communications environment client software application (“client application”) of the user account; detecting presence of the pre-selected type of audio event during the audio processing; sending the meeting audio data from the client application of the user account to the virtual meeting; and wherein rendering the visualization comprises: rendering the visualization during playback of the meeting audio data in the virtual meeting.

Example 3: The method of any Examples 1-2, further comprising: wherein rendering the visualization within the communications environment client software application of the user account comprises: rendering the visualization concurrently with presentation of a video stream associated with the user account in the virtual meeting.

Example 4: The method of any Examples 1-3, further comprising: wherein rendering the visualization comprises: sending the video stream and the received audio data associated with the user account to the virtual meeting; and providing playback of the video stream and the received audio data at the client application of the user concurrently with rendering the visualization during the virtual meeting.

Example 5: The method of any Examples 1-4, further comprising: wherein detecting presence of a pre-selected type of audio event in the received audio data comprises: detecting presence of a first audio event in the received audio data; detecting presence of a second audio event in the received audio data; and wherein generating the visualization comprises: generating the visualization as representing occurrences of the first and the second audio events and a difference of intensity between the first and the second audio events.

Example 6: The method of any Examples 1-5, further comprising: wherein the first audio event comprises a first background noise event; and wherein the second audio event comprises a subsequent second background noise event, wherein an intensity of the first background noise event is different than an intensity of the second background noise event.

Example 7: The method of any Examples 1-6, further comprising: wherein the first audio event comprises a first multi-speaker event; and wherein the second audio event comprises a subsequent second multi-speaker event, wherein an intensity of the first multi-speaker event is different than an intensity of the second multi-speaker event.

Example 8: The method of any Examples 1-7, further comprising: wherein generating a visualization comprises: feeding the received audio data into at least one machine learning model implemented within the communications environment client software application (“client application”) of the user account; receiving visualization output from the machine learning model at the client application of the user account; and wherein rendering the visualization comprises: rendering the machine learning model visualization output via the client application of the user account.

Example 9: The method of any Examples 1-8, further comprising: prior to the virtual meeting, receiving selection of a first type of audio data and a second type of audio data by the user account; wherein detecting presence of a pre-selected type of audio event in the received audio data comprises: detecting an occurrence of the first type of audio data in the received audio data; and detecting an occurrence of the second type of audio data in the received audio data; wherein feeding the received audio data into at least one machine learning model comprises: feeding the respective occurrences of the first type and the second type of audio data into the at least one machine learning model; and wherein receiving visualization output from the machine learning model comprises: receiving visualization output based on a combination of the respective occurrences of the first type and the second type of audio data.

Example 10: A non-transitory computer-readable medium having a computer-readable program code embodied therein to be executed by one or more processors, the program code including instructions for: receiving audio data associated with a user account accessing a virtual meeting via a communications environment client software application; detecting presence of a pre-selected type of audio event in the received audio data; generating a visualization representative of at least one attribute of the detected audio event; and during playback of the audio data in the virtual meeting, rendering the visualization within the communications environment client software application of the user account.

Example 11: The non-transitory computer-readable medium of Example 10, further comprising: wherein detecting presence of a pre-selected type of audio event in the received audio data comprises: generating meeting audio data by performing audio processing of the received audio data via the communications environment client software application (“client application”) of the user account; detecting presence of the pre-selected type of audio event during the audio processing; sending the meeting audio data from the client application of the user account to the virtual meeting; and wherein rendering the visualization comprises: rendering the visualization during playback of the meeting audio data in the virtual meeting.

Example 12: The non-transitory computer-readable medium of any Examples 10-11, further comprising: wherein rendering the visualization within the communications environment client software application of the user account comprises: rendering the visualization concurrently with presentation of a video stream associated with the user account in the virtual meeting.

Example 13: The non-transitory computer-readable medium of any Examples 10-12, further comprising: wherein rendering the visualization comprises: sending the video stream and the received audio data associated with the user account to the virtual meeting; and providing playback of the video stream and the received audio data at the client application of the user concurrently with rendering the visualization during the virtual meeting.

Example 14: The non-transitory computer-readable medium of any Examples 10-13, further comprising: wherein detecting presence of a pre-selected type of audio event in the received audio data comprises: detecting presence of a first audio event in the received audio data; detecting presence of a second audio event in the received audio data; and wherein generating the visualization comprises: generating the visualization as representing occurrences of the first and the second audio events and a difference of intensity between the first and the second audio events.

Example 15: The non-transitory computer-readable medium of any Examples 10-14, further comprising: wherein the first audio event comprises a first change in speech quality in the audio data; and wherein the second audio event comprises a subsequent second change in speech quality in the audio data, wherein an intensity of the first change is different than an intensity of the second change.

Example 16: The non-transitory computer-readable medium of any Examples 10-15, further comprising: wherein the first audio event comprises a first audio loss event; and wherein the second audio event comprises a subsequent second audio loss event, wherein an extant of the first audio loss event is different than an extant of the second audio loss event.

Example 17: A communication system comprising one or more processors configured to perform the operations of: receiving audio data associated with a user account accessing a virtual meeting via a communications environment client software application; detecting presence of a pre-selected type of audio event in the received audio data; generating a visualization representative of at least one attribute of the detected audio event; and during playback of the audio data in the virtual meeting, rendering the visualization within the communications environment client software application of the user account.

Example 18: The communication system of any Examples 17, further comprising: wherein rendering the visualization comprises: defining a visualization background based on the visualization, the visualization background comprising a virtual background for a video stream associated with the user account; merging the virtual background with video data captured at a computer device associated with the user account; and displaying a video stream associated with the user account, the video stream portraying the visualization background.

Example 19: The communication system of any Examples 17-18, further comprising:
wherein in a type of audio event comprises detection of an occurrence one of: an instance of voice activity, an instance of background noise, an instance of multi-speaker voice activity, a presence of music, an instance of a variation in audio quality.

Example 20: The communication system of any Examples 17-19, further comprising:
wherein receiving audio data comprises: determining one or more attributes of the audio data for generation of the visualization, the one or more attributes including at least one of: frequency data, spectral data, energy data.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method comprising:
receiving audio data associated with a user account accessing a virtual meeting via a communications environment client software application;
detecting presence of a pre-selected type of audio event in the received audio data;
generating a visualization representative of at least one attribute of the detected audio event; and
during playback of the audio data in the virtual meeting, rendering the visualization within the communications environment client software application of the user account.

2. The computer-implemented method of claim 1, wherein detecting presence of a pre-selected type of audio event in the received audio data comprises:
generating meeting audio data by performing audio processing of the received audio data via the communications environment client software application (“client application”) of the user account;
detecting presence of the pre-selected type of audio event during the audio processing;
sending the meeting audio data from the client application of the user account to the virtual meeting; and
wherein rendering the visualization comprises:
rendering the visualization during playback of the meeting audio data in the virtual meeting.

3. The computer-implemented method of claim 1, wherein rendering the visualization within the communications environment client software application of the user account comprises:
rendering the visualization concurrently with presentation of a video stream associated with the user account in the virtual meeting.

4. The computer-implemented method of claim 3, wherein rendering the visualization comprises:
sending the video stream and the received audio data associated with the user account to the virtual meeting; and
providing playback of the video stream and the received audio data at the client application of the user concurrently with rendering the visualization during the virtual meeting.

5. The computer-implemented method of claim 1, wherein detecting presence of a pre-selected type of audio event in the received audio data comprises:
detecting presence of a first audio event in the received audio data;
detecting presence of a second audio event in the received audio data; and
wherein generating the visualization comprises:
generating the visualization as representing occurrences of the first and the second audio events and a difference of intensity between the first and the second audio events.

6. The computer-implemented method of claim 5, further comprising:
wherein the first audio event comprises a first background noise event; and
wherein the second audio event comprises a subsequent second background noise event, wherein an intensity of the first background noise event is different than an intensity of the second background noise event.

7. The computer-implemented method of claim 5, further comprising:
wherein the first audio event comprises a first multi-speaker event; and
wherein the second audio event comprises a subsequent second multi-speaker event, wherein an intensity of the first multi-speaker event is different than an intensity of the second multi-speaker event.

8. The computer-implemented method of claim 1, wherein generating a visualization comprises:
feeding the received audio data into at least one machine learning model implemented within the communications environment client software application (“client application”) of the user account;
receiving visualization output from the machine learning model at the client application of the user account; and
wherein rendering the visualization comprises:
rendering the machine learning model visualization output via the client application of the user account.

9. The computer-implemented method of claim 8, further comprising:
prior to the virtual meeting, receiving selection of a first type of audio data and a second type of audio data by the user account;
wherein detecting presence of a pre-selected type of audio event in the received audio data comprises:
detecting an occurrence of the first type of audio data in the received audio data; and
detecting an occurrence of the second type of audio data in the received audio data;
wherein feeding the received audio data into at least one machine learning model comprises: feeding the respective occurrences of the first type and the second type of audio data into the at least one machine learning model; and
wherein receiving visualization output from the machine learning model comprises: receiving visualization output based on a combination of the respective occurrences of the first type and the second type of audio data.

10. A non-transitory computer-readable medium having a computer-readable program code embodied therein to be executed by one or more processors, the program code including instructions for:
receiving audio data associated with a user account accessing a virtual meeting via a communications environment client software application;
detecting presence of a pre-selected type of audio event in the received audio data;
generating a visualization representative of at least one attribute of the detected audio event; and
during playback of the audio data in the virtual meeting, rendering the visualization within the communications environment client software application of the user account.

11. The non-transitory computer-readable medium of claim 10, wherein detecting presence of a pre-selected type of audio event in the received audio data comprises:
generating meeting audio data by performing audio processing of the received audio data via the communications environment client software application (“client application”) of the user account;
detecting presence of the pre-selected type of audio event during the audio processing;
sending the meeting audio data from the client application of the user account to the virtual meeting; and
wherein rendering the visualization comprises:
rendering the visualization during playback of the meeting audio data in the virtual meeting.

12. The non-transitory computer-readable medium of claim 10, wherein rendering the visualization within the communications environment client software application of the user account comprises:
rendering the visualization concurrently with presentation of a video stream associated with the user account in the virtual meeting.

13. The non-transitory computer-readable medium of claim 12, wherein rendering the visualization comprises:
sending the video stream and the received audio data associated with the user account to the virtual meeting; and
providing playback of the video stream and the received audio data at the client application of the user concurrently with rendering the visualization during the virtual meeting.

14. The non-transitory computer-readable medium of claim 10, wherein detecting presence of a pre-selected type of audio event in the received audio data comprises:
detecting presence of a first audio event in the received audio data;
detecting presence of a second audio event in the received audio data; and
wherein generating the visualization comprises:
generating the visualization as representing occurrences of the first and the second audio events and a difference of intensity between the first and the second audio events.

15. The non-transitory computer-readable medium of claim 14, further comprising:
wherein the first audio event comprises a first change in speech quality in the audio data; and
wherein the second audio event comprises a subsequent second change in speech quality in the audio data, wherein an intensity of the first change is different than an intensity of the second change.

16. The non-transitory computer-readable medium of claim 14, further comprising:
wherein the first audio event comprises a first audio loss event; and
wherein the second audio event comprises a subsequent second audio loss event event, wherein an extant of the first audio loss event is different than an extant of the second audio loss event.

17. A communication system comprising one or more processors configured to perform the operations of:
receiving audio data associated with a user account accessing a virtual meeting via a communications environment client software application;
detecting presence of a pre-selected type of audio event in the received audio data;
generating a visualization representative of at least one attribute of the detected audio event; and
during playback of the audio data in the virtual meeting, rendering the visualization within the communications environment client software application of the user account.

18. The communications system of claim 17, wherein rendering the visualization comprises:
defining a visualization background based on the visualization, the visualization background comprising a virtual background for a video stream associated with the user account;
merging the virtual background with video data captured at a computer device associated with the user account; and
displaying a video stream associated with the user account, the video stream portraying the visualization background.

19. The communications system of claim 17, wherein in a type of audio event comprises detection of an occurrence one of: an instance of voice activity, an instance of background noise, an instance of multi-speaker voice activity, a presence of music, an instance of a variation in audio quality.

20. The communications system of claim 17, wherein receiving audio data comprises:
determining one or more attributes of the audio data for generation of the visualization, the one or more attributes including at least one of: frequency data, spectral data, energy data.
